(19) United States
(12) Patent Application Publication
(10) Pub. No.: US 2026/0304561 A1
(43) Pub. Date: Oct. 1, 2026

(54) LOAD ADJUSTABLE ELECTRODE HOT WATER BOILER

(71) Applicants: SHANGHAI FANGKUAI BOILER CO., LTD., SHNGHAI (CN); FANGKUAI BOILER CO., LTD., ANYANG (CN)

(72) Inventors: HAIGANG LU, SHANGHAI (CN); JIE LU, SHANGHAI (CN); JUNYI FENG, SHANGHAI (CN); SONGLIN LIU, SHANGHAI (CN); CHENXING PAN, SHANGHAI (CN)

(73) Assignees: SHANGHAI FANGKUAI BOILER CO., LTD., SHANGHAI (CN); FANGKUAI BOILER CO., LTD., ANYANG (CN)

(21) Appl. No.: 19/173,939

(22) Filed: Apr. 9, 2025

(30) Foreign Application Priority Data
Feb. 25, 2025 (CN) 202510209534.3

(51) Int. Cl. H05B 3/00; H05B 1/02; H05B 3/03; H05B 3/04; H05B 3/60

(52) U.S. Cl. CPC H05B 3/0009; H05B 1/0283; H05B 3/03; H05B 3/04; H05B 3/60; H05B 2203/021

(57) ABSTRACT

A load adjustable electrode hot water boiler includes a drum, zero electrode cylinders, phase electrodes, and water distributors. The amount of the zero electrode cylinders is three, and the zero electrode cylinders are evenly and annularly distributed in the drum. The phase electrodes are coaxially disposed in the zero electrode cylinders respectively. The water distributors are located directly below the zero electrode cylinders respectively. An isolation shield is slidably assembled with a corresponding one of the water distributors, and the isolation shield is configured to rotate and lift relative to the corresponding water distributor; and the isolation shield is further configured to sleeve on a corresponding one of the phase electrodes during a rising process of the isolation shield, thereby isolating an ion migration between the corresponding phase electrode and a corresponding one of the zero electrode cylinders.

### TECHNICAL FIELD

The present disclosure relates to the technical field of hot water boilers, in particular to a load adjustable electrode hot water boiler.

### BACKGROUND

Electrode hot water boiler is a device that uses the heat generated by a resistance between the electrode and water to heat water, which has a wide range of applications in many fields. A basic operating principle of an electrode hot water boiler is based on resistance of water. When an electrode is inserted into the water and the electrode is powered on, the current passes through the water. Since the water has a certain resistance, the current will generate heat when it flows in the water. By controlling the voltage and current of the electrode, the generated heat can be accurately adjusted, so as to achieve a purpose of heating water.

However, in a Chinese patent document with a publication number of CN113865081B, an automatic descaling electrode boiler is disclosed, which includes a furnace body having a water inlet and a water outlet, a cylindrical zero electrode located in the furnace body, a phase electrode coaxially arranged in the zero electrode, and a driving mechanism. Specifically, an insulation sleeve is coaxial with both the zero electrode and the phase electrode, the insulation sleeve is connected to the driving mechanism and can rise and descend under the driving of the driving mechanism. An inner side of the insulation sleeve is provided with an inner cleaning ring, and the inner cleaning ring is fixed coaxially with insulation sleeve. The phase electrode is located in the inner cleaning ring, and the insulation sleeve serves as a barrier between the phase electrode and the zero position electrode. The driving mechanism drives the insulation sleeve to rise and descend, thereby adjusting a contact area between the phase electrode and the zero electrode through the up and down movement of the insulation sleeve, and achieving the purpose of adjusting power. This adjustment response is fast, the action is sensitive, and it can achieve stepless adjustment. Meanwhile, by installing the inner cleaning ring on the inside of the insulation sleeve, the surface of the phase electrode can be cleaned during the up and down movement of the insulation sleeve, thereby avoiding the formation of scale on the surface of the phase electrode and affecting its normal operation.

However, there are following problems in the above disclosure: an end surface of the phase electrode is a curved surface, and the inner cleaning ring cannot cover the end face of the phase electrode when cleaning it. Surfaces of the phase electrode cannot be fully cleaned, and the scale covering the end face of the phase electrode will cause uneven heat distribution on its surface, thereby resulting in high temperature in local areas, affecting heating efficiency, and accelerating the aging and damage of the phase electrode. In addition, the inner cleaning ring is always attached to the surface of the phase electrode during operation, which will also block the surface of the phase electrode and cause negative effects similar to scale, which is not conducive to the normal operation of the phase electrode.

### SUMMARY

The present disclosure provides a load adjustable electrode hot water boiler. The present disclosure aims at solving the problem in related art that an end surface of a phase electrode cannot be covered when the phase electrode is cleaned, and the cleaning of the phase electrode cannot be fully covered.

The load adjustable electrode hot water boiler provided by the present disclosure includes a drum, zero electrode cylinders, phase electrodes, and water distributors. The amount of the zero electrode cylinders is three, and the zero electrode cylinders are evenly and annularly distributed in the drum. The phase electrodes are coaxially disposed in the zero electrode cylinders respectively. The water distributors are located directly below the zero electrode cylinders respectively. An isolation shield is slidably assembled with a corresponding one of the water distributors, and the isolation shield is configured to rotate and lift relative to the corresponding water distributor. The isolation shield is further configured to sleeve on a corresponding one of the phase electrodes during a rising process of the isolation shield, thereby isolating an ion migration between the corresponding phase electrode and a corresponding one of the zero electrode cylinders.

A top of the isolation shield is provided with vertical plates and curved plates. The vertical plates are configured to slide radially along the isolation shield, and the vertical plates are further configured to attach tightly to a surface of the corresponding phase electrode and move away from the surface of the corresponding phase electrode by sliding. The curved plates are rotatably disposed at ends of the vertical plates respectively; and the curved plates are configured to attach to a curved surface of the corresponding phase electrode with a movement of the corresponding isolation shield.

In an embodiment, the drum is fixedly installed with a support and a base located below the support, the zero electrode cylinders are fixedly installed on the support, and the water distributors are disposed on the base.

In an embodiment, a bracket is provided above the base, hold hoops are provided on the bracket, and the isolation shield is rotatably assembled in a corresponding one of the hold hoops.

In an embodiment, an inside of the base is provided with a lead screw, and a bottom end of the lead screw extends to an outside of the drum and is connected to a servo motor. A nut is fixedly installed in the bracket; and the nut is threaded with an outside of the lead screw.

In an embodiment, an outside of each of the water distributors is provided with a rotary table, and a top of the rotary table is fixedly installed with telescopic rods. A telescopic end of each of the telescopic rods is fixedly connected to the isolation shield. An outside of the rotary table is fixedly installed with a ring gear. The outside of the lead screw is fixedly installed with a gear that meshes with the ring gear.

In an embodiment, the top of the isolation shield is fixedly installed with support blocks, and an inside of each of the support blocks is slidably connected to a horizontal bar. The horizontal bar is horizontally disposed along a radial direction of the isolation shield. An installation plate is fixedly installed on the horizontal bar and the installation plate is located at a side of the support block. A spring is provided between the installation plate and the support block; and the spring is in a compressed state. The vertical plate is fixedly installed at an end of the horizontal bar. A torsion spring is provided between the a corresponding one of the vertical plates and a corresponding one of the curved plates, and the torsion spring is configured to apply a torsion force to the corresponding curved plate along a centerline of the corresponding phase electrode.

In an embodiment, an outside of the isolation shield is provided with an annular plate that slides along a height direction of the isolation shield, a bottom of the annular plate is provided with an air cylinder, and the air cylinder is configured to drive the annular plate to rise and descend. A top of the annular plate is fixedly installed with a wedge-shaped plate, and a side of the wedge-shaped plate facing away from the isolation shield is an inclined surface. An inside of the horizontal bar defines a transverse slot along its length direction. A top of the wedge-shaped plate is slidably connected to the transverse slot.

In an embodiment, a top of the drum is fixedly installed with electrode tube seats. An inside of each of the electrode tube seats is fixedly installed with an electrode porcelain sleeve. The corresponding phase electrode is fixedly installed at a bottom of the electrode porcelain sleeve. A wire clamp is provided at a top of the electrode porcelain sleeve, and a conductive copper rod is provided between the wire clamp and the corresponding phase electrode.

In an embodiment, an outside of the electrode porcelain sleeve is provided with a protruding ring seat disposed in the electrode tube seat, and sealing rings are provided on two sides of the protruding ring seat. A surface of each of the sealing rings facing towards the protruding ring seat is a spherical curved surface. A surface of each of the sealing rings facing away from the protruding ring seat is a plane.

In an embodiment, a bottom of each of the electrode tube seats is provided with an upper insulation sheath, and a top of each of the water distributors is provided with a lower insulation sheath.

The present disclosure has the following beneficial effects:

1. When the present disclosure is in use, the load adjustment of the load adjustable electrode hot water boiler is achieved by adjusting a blocking area between the zero electrode cylinder and the phase electrode based on the rotation and lifting of the isolation shield. The vertical plates and the curved plates cooperate with each other to comprehensively clean surfaces of the phase electrode during the lifting of the isolation shield, thereby effectively preventing scale from condensing and accumulating on the surfaces of the phase electrode, maintaining a good conductive heating effect of the phase electrode, and increasing the service life of the phase electrode. The vertical plates and the curved plates can generate a vortex in the electrolyte aqueous solution in the zero electrode cylinder during rotation, which can quickly separate the cleaned scale from the phase electrode, vertical plates, and curved plates, and then the cleaned scale is discharged together with the electrolyte solution to prevent scale from accumulating on the vertical plates and curved plates.

2. When the present disclosure is in use, by lifting the wedge-shaped plate, the horizontal bar can be pushed to slide within the support block, the vertical plates can move away from the phase electrode when phase electrode does not need to be cleaned, thereby avoiding a large area of the phase electrode from being blocked by the vertical plates during operation, making the surface heat of the phase electrode evenly distributed, and maintaining a good working state of the phase electrode.

3. When the present disclosure is in use, the present disclosure achieves spherical sealing between the protruding ring seat and the sealing ring by contacting the spherical curved surface of the sealing ring with the protruding ring seat, thereby reducing friction and enhancing wear resistance. This design enables the sealing ring to better adapt to harsh environments such as high pressure and high temperature, and the sealing ring is suitable for spans at different angles. The electrode ceramic sleeve can be flexibly adjusted in angle during assembly, thereby ensuring sealing performance.

### BRIEF DESCRIPTION OF DRAWINGS

FIG. 1 is a perspective view of the present disclosure.

FIG. 2 is a front view of the present disclosure.

FIG. 3 is a side view of the present disclosure.

FIG. 4 is a cross-sectional view of FIG. 3 of the present disclosure.

FIG. 5 is an enlarged structural view of portion A in FIG. 4 of the present disclosure.

FIG. 6 is a perspective view of an inside of a drum of the present disclosure.

FIG. 7 is a front view of FIG. 6 of the present disclosure.

FIG. 8 is a perspective view of an isolation shield and a bracket of the present disclosure.

FIG. 9 is a perspective view of the isolation shield and a phase electrode of the disclosure.

FIG. 10 is an enlarged structural view of portion B in FIG. 9 of the present disclosure.

### DESCRIPTION OF REFERENCE NUMERALS

10—drum; 11—zero electrode cylinder; 12—phase electrode; 13—water distributor; 14—support; 15—base; 151—discharge pipe; 152—cone; 16—electrode tube seat; 17—upper insulation sheath; 18—lower insulation sheath; 20—power adjustment assembly; 21—bracket; 22—isolation shield; 23—hold hoop; 30—driving mechanism; 31—servo motor; 32—lead screw; 33—nut; 40—transmission mechanism; 41—rotary table; 42—telescopic rod; 43—ring gear; 44—gear; 50—cleaning mechanism; 51—support block; 52—horizontal bar; 521—installation plate; 522—spring; 523—transverse slot; 53—scraper; 531—vertical plate; 532—curved plate; 60—pushing mechanism; 61—annular plate; 62—air cylinder; 63—wedge-shaped plate; 70—electrode insulation device; 71—conductive copper rod; 72—electrode porcelain sleeve; 73—wire clamp; 74—sealing assembly; 741—protruding ring seat; 742—sealing ring.

### DETAILED DESCRIPTION OF EMBODIMENTS

Embodiments of the present disclosure are described in detail below, and a part of the embodiments are shown in the drawings. The embodiments described below with reference to the drawings are exemplary and intended to explain the present disclosure, and the following embodiments should not be construed as limitations of the present disclosure.

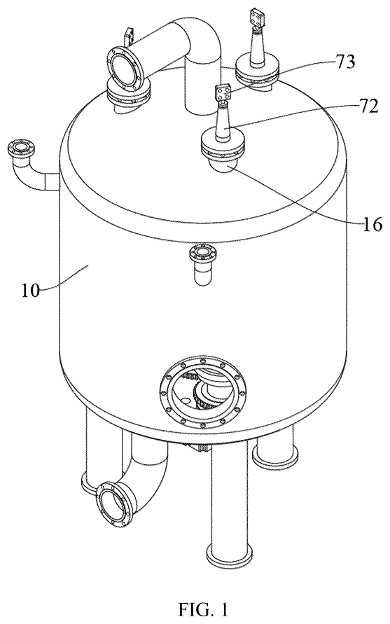

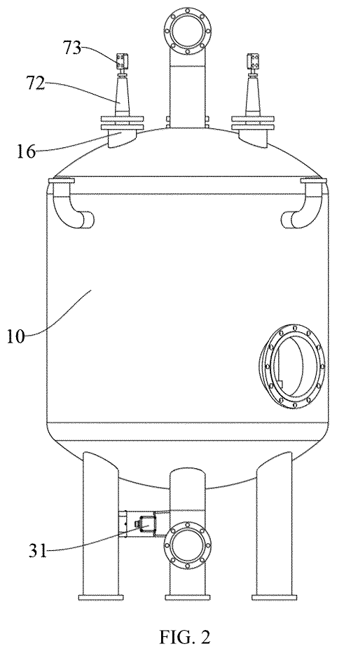

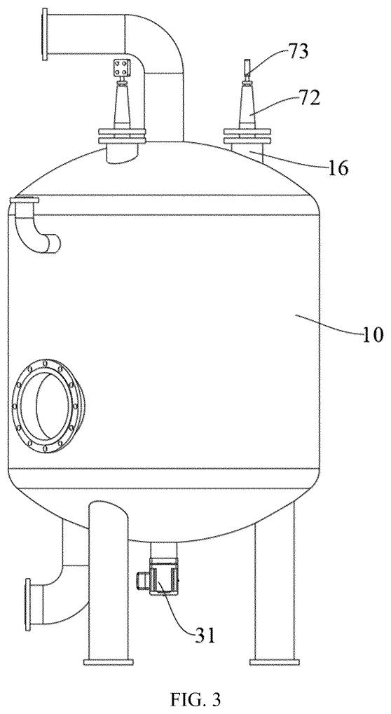

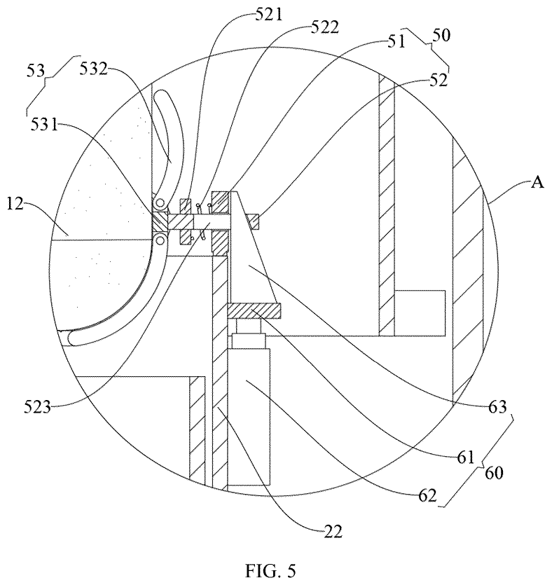

As shown in FIG. 1 to FIG. 10, the load adjustable electrode hot water boiler includes a drum 10, zero electrode cylinders 11, phase electrodes 12, water distributors 13, a power adjustment assembly 20, a driving mechanism 30, a transmission mechanism 40, a cleaning mechanism 50, and a pushing mechanism 60. The zero electrode cylinders 11 and the phase electrodes 12 are correspondingly arranged in the drum 10 for heating an electrolyte aqueous solution. Each of the water distributors 13 is located below a corresponding one of the zero electrode cylinders 11. The water distributor 13 is configured for dispersing and transporting the electrolyte aqueous solution. The power adjustment assembly 20 is located below the zero electrode cylinders 11 and can adjust the working load of the load adjustable electrode hot water boiler under the driving of the driving mechanism 30. The cleaning mechanism 50 is installed on the power adjustment assembly 20. The cleaning mechanism 50 is configured to clean scale on the phase electrodes 12 under the action of the transmission mechanism 40, and the cleaning mechanism 50 can move away from the phase electrodes 12 under the action of the pushing mechanism 60.

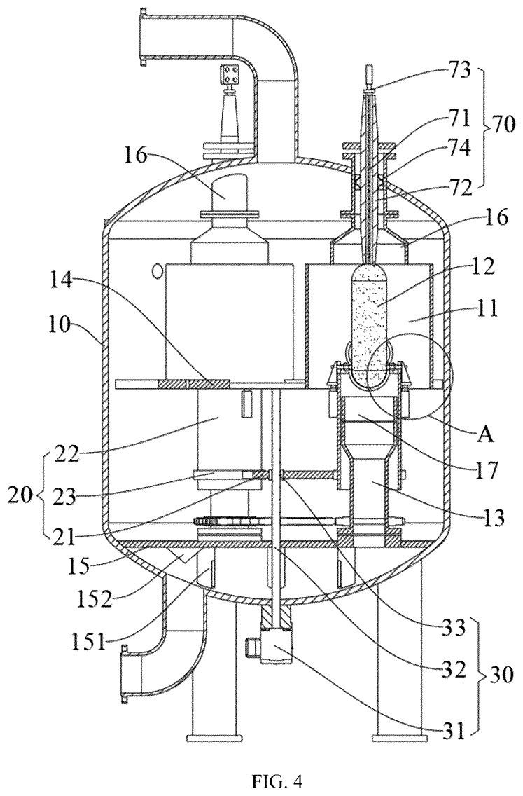

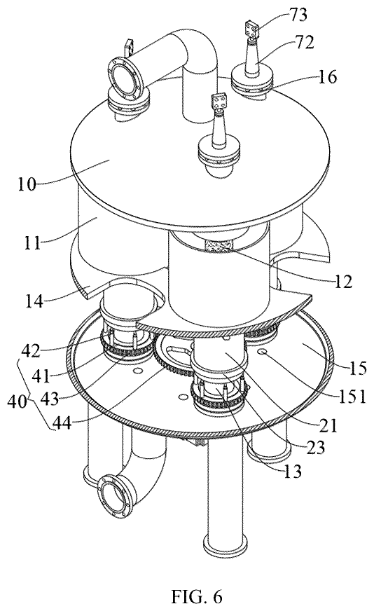

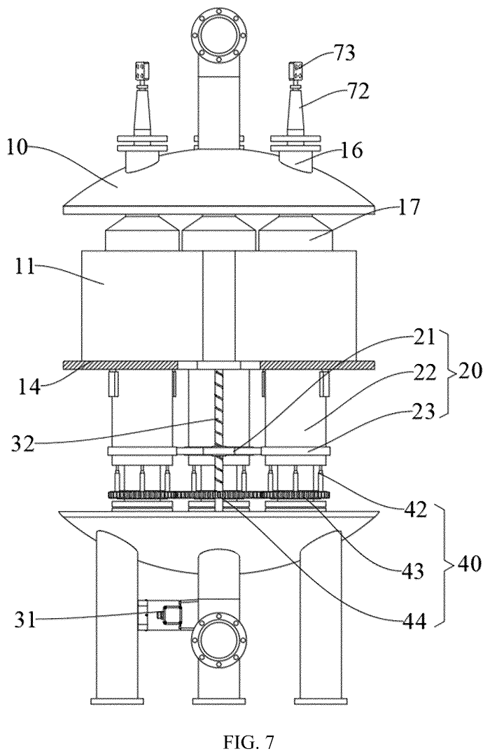

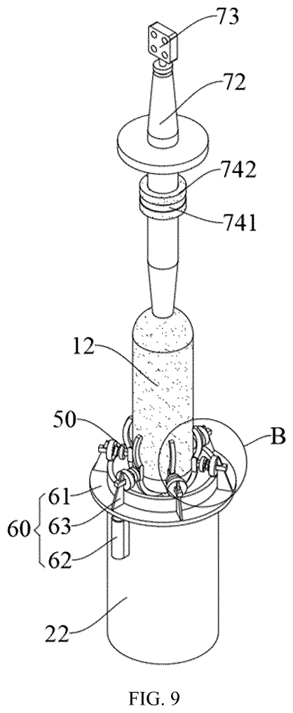

As shown in FIG. 4, FIG. 6, FIG. 7, and FIG. 9, an inside of the drum 10 is fixedly installed with a support 14 and a base 15. The support 14 is located in a middle of the drum 10. The base 15 is located in a lower end head of the drum 10, and the zero electrode cylinders 11 are fixedly installed on the support 14. There are three zero electrode cylinders 11, which are evenly distributed in a circular shape. A top of the drum 10 is provided with electrode tube seats 16, an inside of each of the electrode tube seats 16 is provided with an electrode insulation device 70. Each phase electrode 12 is suspended in a middle of a corresponding zero electrode cylinder 11 through the electrode insulation device 70. The water distributors 13 are disposed on the base 15. The three water distributors 13 are disposed directly below the three zero electrode cylinders 11 respectively. A bottom of the drum 10 is provided with a water inlet pipe and a discharge outlet, and the top of drum 10 is provided with a water outlet pipe, making the electrolyte aqueous solution to circulate from the bottom of the drum to the top of the drum 10.

The base 15 is circular. The base 15 is provided with discharge pipes 151 and a cone 152 is disposed on the base 15.

The discharge pipes 151 are evenly distributed at the bottom of the base 15, which makes upper and lower sides of the base 15 be connected, so that the electrolyte aqueous solution in the drum 10 can enter the bottom of the drum 10 through the discharge pipes 151, and then the electrolyte aqueous solution is discharged from the discharge outlet at the bottom of the drum 10. At the same time, the discharge pipes 151 can also support the base 15.

The cone 152 is disposed directly above the water inlet at the bottom of drum 10. A tip of the cone 152 faces downwards, which effectively disperses the impact force of water to a larger area, reduces the impact of water on flat plates, and further protects the structural stability of the present disclosure.

A bottom of each electrode tube seat 16 is provided with an upper insulation sheath 17, and the top of each water distributor 13 is provided with a lower insulation sheath 18. Both the upper insulation sheath 17 and the lower insulation sheath 18 are made of polytetrafluoroethylene insulation material, which can isolate and extend the water current path.

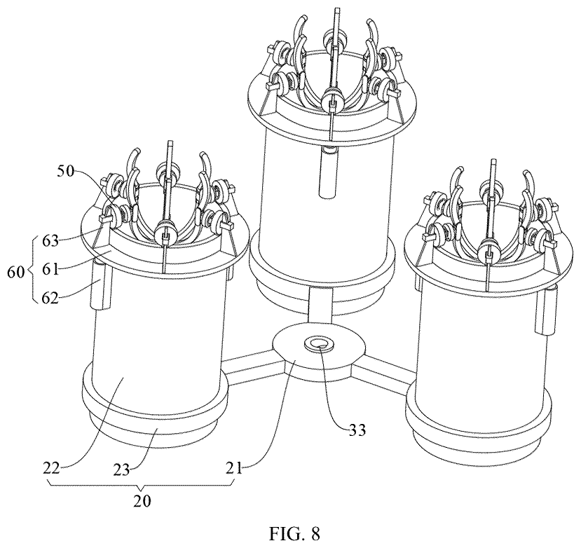

As shown in FIG. 4, FIG. 7, and FIG. 8, the power adjustment assembly 20 includes a bracket 21, isolation shields 22, and hold hoops 23. The bracket 21 is located above the base 15. The amount of the isolation shields 22 is three and a shape of each isolation shield 22 is cylindrical. The isolation shields 22 are rotatably assembled on the bracket 21 through the hold hoops 23. The three isolation shields 22 are respectively sleeved on the three water distributors 13, and the three isolation shields 22 can rise and descend relative to the water distributors 13, so that a top of each isolation shield 22 can extend into the zero electrode cylinder 11 and sleeved on the phase electrode 12, and thus the zero electrode cylinder 11 is isolated from the phase electrode 12 and the working load of the load adjustable electrode hot water boiler can be adjusted.

As shown in FIG. 4, FIG. 7, and FIG. 8, a driving mechanism 30 includes a servo motor 31, a lead screw 32, a nut 32. The servo motor 31 is fixedly installed at the bottom of the drum 10, and the lead screw 32 is rotatably assembled between the drum 10 and the base 15. The bottom of the lead screw 32 is connected to the servo motor 31 through a coupling, and the nut 33 is threaded with the lead screw 32 and fixed to the bracket 21. The servo motor 31 is configured to drive the lead screw 32 to rotate, the nut 33 is pushed to rise and descend the bracket 21 and the isolation shield 22, and thus the height of the isolation shield 22 is adjusted.

As shown in FIG. 6 and FIG. 7, a transmission mechanism 40 includes rotary tables 41, telescopic rods 42, a ring gear 43, and a gear 44. Each rotary table 41 is rotatably installed on the water distributor 13, and the telescopic rods 42 are fixedly installed at a top of the rotary table 41. A telescopic end of each telescopic rod 42 is fixedly connected to the isolation shield 22, and the rotary table 41 can be driven to rotate without affecting the lifting of the isolation shield 22. The ring gear 43 is fixedly installed on the rotary table 41. The gear 44 is fixedly installed on the lead screw 32 and meshes with ring gear 43. When the lead screw 32 pushes the isolation shield 22 up and down, the gear 44 can be driven to rotate, thereby driving the ring gear 43 to rotate the rotary table 41. The isolation shield 22 can be rotated while the isolation shield 22 is lifted, thereby enabling the cleaning mechanism 50 to clean the phase electrode 12.

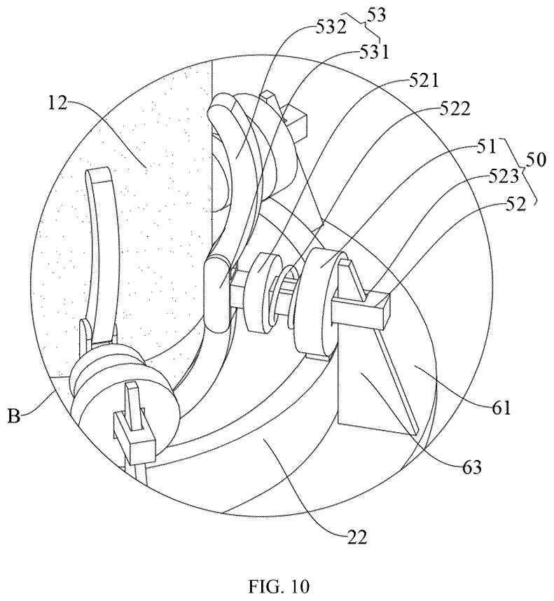

As shown in FIG. 9 and FIG. 10, the cleaning mechanism 50 includes a support block 51, a horizontal bar 52, and a scraper 53. The support block 51 is fixedly installed at a top of an isolation shield 22, and the horizontal bar 52 slides horizontally along a radial direction of the isolation shield 22 and is set inside the support block 51. The scraper 53 is set at an end of the horizontal bar 52 and is close to the phase electrode 12. The cleaning mechanism 50 is configured to remove scale on the phase electrode 12 during the rotation and lifting of the isolation shield 22, so that the scale can be discharged to the outside of the drum 10 as the electrolyte aqueous solution is discharged. An installation plate 521 disposed at a side of the support block 51 is fixedly installed on the horizontal bar 52. A spring 522 is provided between the installation plate 521 and the support block 51. The spring 522 is in a compressed state, so as to apply a pushing force to the installation plate 521 in a direction of the phase electrode 12, so that the scraper 53 can closely attach to a side wall of the phase electrode 12.

The scraper 53 includes a vertical plate 531 and curved plates 532. The vertical plate 531 is fixedly installed at an end of the horizontal bar 52, and a side of the vertical plate 531 close to the phase electrode 12 is a curved surface, so that the vertical plate 531 can closely attach to the side of the phase electrode 12, thereby better cleaning the side of the phase electrode 12. The amount of the curved plates 532 is two, and the curved plates 532 are rotatably installed on upper and lower ends of the vertical plate 531 respectively. The two curved plates 532 are respectively adapted to curvatures of upper and lower end surfaces of the phase electrode 12, and a torsion spring is provided between the curved plates 532 and the vertical plate 531. The torsion spring can apply a torsion force to the curved plates 532 in a direction of the phase electrode 12. When the curved plates 532 move to an end of the phase electrode 12, the curved plates 532 can be rotated and attach to a curved end surface of the phase electrode 12 under the torsion force of the torsion spring, thereby completing the cleaning of the curved end surface of the phase electrode 12.

As shown in FIG. 9 and FIG. 10, the pushing mechanism 60 includes an annular plate 61, an air cylinder 62, and a wedge-shaped plate 63. The annular plate 61 is slidably connected to the isolation shield 22. The air cylinder 62 is fixed to the isolation shield 22 at a bottom of the annular plate 61. The wedge-shaped plate 63 is fixedly installed at a top of the annular plate 61. A side of the wedge-shaped plate 63 facing away from the isolation shield 22 is an inclined surface, and a width of the wedge-shaped plate 63 gradually increases from top to bottom. The horizontal bar 52 defines a transverse slot 523 along a length direction of the horizontal bar 52. A top of the wedge-shaped plate 63 is disposed in the transverse slot 523. When the air cylinder 62 pushes the annular plate 61 to rise and the wedge-shaped plate 63 slides in the transverse slot 523, the wedge-shaped plate 63 can push the horizontal bar 52 to slide in the support block 51, so that the vertical plate 531 moves away from the phase electrode 12, then a contact area between the cleaning mechanism 50 and the phase electrode 12 is reduced, and the work efficiency of the phase electrode 12 will not be affected.

As shown in FIG. 4 and FIG. 9, the electrode insulation device 70 includes a conductive copper rod 71, an electrode porcelain sleeve 72, a wire clamp 73, and a sealing assembly 74. The electrode porcelain sleeve 72 is vertically fixed on the electrode tube seat 16 through a flange. A bottom of the electrode porcelain sleeve 72 extends to the inside of the drum 10. The phase electrode 12 is fixedly installed at a bottom of the electrode porcelain sleeve 72. The wire clamp 73 is disposed at a top of the electrode porcelain sleeve 72 for connecting high-voltage cables. The conductive copper rod 71 penetrates into the electrode porcelain sleeve 72. Upper and lower ends of the electrode porcelain sleeve 72 are respectively fixed to the wire clamp 73 and the phase electrode 12 respectively. The wire clamp 73 is connected to the phase electrode 12. The sealing assembly 74 is located between the electrode porcelain sleeve 72 and the electrode tube seat 16, which can achieve the sealing between the electrode porcelain sleeve 72 and the electrode tube seat 16.

The sealing assembly 74 includes a protruding ring seat 741 and sealing rings 742. The protruding ring seat 741 is disposed on the electrode porcelain sleeve 72. The amount of the sealing rings 742 is two, and the sealing rings 742 are disposed at upper and lower sides of the protruding ring seat 741. Surfaces of the sealing rings 742 close to the protruding ring seat 741 are spherical curved surfaces. Surfaces of the sealing rings 742 facing away from the protruding ring seat 741 are planes. Spherical sealing is adopted between the protruding ring seat 741 and the sealing rings 742, which can reduce friction and enhance wear resistance. The sealing rings 742 are suitable for harsh environments with high pressure and high temperature, and the sealing rings 742 are suitable for spans at different angles. The electrode porcelain sleeve tube 72 can be flexibly adjusted in angle during assembly to ensure sealing performance.

In the present disclosure, three-phase alternating current is applied to the phase electrode 12 at a center of the zero electrode cylinder 11 through the electrode insulation device 70. Three zero electrode cylinders 11 are evenly distributed around a circumference of the drum 10. A distance from an outer surface of each phase electrode 12 to an inner wall of a respective zero electrode cylinder 11 is equal. After the load adjustable electrode hot water boiler is powered on, under the action of electric field force, an ion migration cross-section and an ion migration distance of the electrolyte aqueous solution in each zero electrode cylinder 11 are equal, the heating of each zero electrode cylinder 11 is uniform, the working load of each zero electrode cylinder 11 is equal, and the three-phase balance of the zero electrode cylinders 11 is high. The three zero electrode cylinders 11 form a whole, and the three zero electrode cylinders 11 forms a current circuit with the phase electrodes 12 and the electrolyte aqueous solution after being energized. The zero electrode cylinder 11 severs as a common neutral point for electrode operation, so as to define a Y-shaped connection that can perfectly adapt to the alternating current.

By driving the isolation shield 22 to rise and descend through the driving mechanism 30, a current channel between the zero electrode cylinder 11 and the phase electrode 12 is blocked. When the isolation shield 22 rises, a blocking area between the zero electrode cylinder 11 and the phase electrode 12 increases, which extends a current path and reduces the working load during heating; when the isolation shield 22 descends, the blocking area between the zero electrode cylinder 11 and the phase electrode 12 decreases, which reduces the current path and increases the working load during heating, thereby achieving adjustments of the working load.

During the rising and descending of the isolation shield 22, the vertical plate 531 is tightly attached to the side wall of the phase electrode 12 under the action of the spring 522, which can clean the scale on the surface of the phase electrode 12. The end of the curved plate 532 is blocked by the phase electrode 12, and then the end of the curved plate 532 rotates in the vertical plate 531 to compress the torsion spring, so that the torsion spring maintains its torsion force on the curved plate 532. The transmission mechanism 40 drives the isolation shield 22 to rotate during the rising and descending process of the isolation shield 22, so that the vertical plate 531 can rotate around the phase electrode 12 to clean the surface of the phase electrode 12 and increase the cleaning area. When the vertical plate 531 moves to an end of the phase electrode 12, the curved plate 532 automatically attaches to a curved end surface of the phase electrode 12 under the action of the torsion spring, and the curved plate 532 is rotated with the vertical plate 531 to clean the curved end surface of the phase electrode 12, which enhances the cleaning of the scale on surfaces of the phase electrode 12. At the same time, when the vertical plate 531 and the curved plate 532 are rotated, they can stir the electrolyte aqueous solution in the zero electrode cylinder 11 to form a vortex, and the vortex flushes the scale on the vertical plate 531 and the curved plate 532. After the scale is quickly removed after being cleaned from the phase electrode 12, the scale can be discharged with the electrolyte aqueous solution, which effectively avoiding a scale layer formed on phase electrode 12 due to the accumulation of the scale.

By rising the wedge-shaped plate 63 and pushing the horizontal bar 52 to move within the support block 51, the vertical plate 531 can move away from the surface of the phase electrode 12, avoiding the vertical plate 531 from blocking the phase electrode 12 during heating and ensuring the uniformity of the work done by the phase electrode 12. When the phase electrode 12 is need to be cleaned, the wedge-shaped plate 63 can be descended to contact the horizontal bar 52, and the vertical plate 531 can automatically attach to the surface of the phase electrode 12 under the action of the spring 522, which facilitates the cleaning of the scale.

Although the embodiments of the present disclosure have been shown and described above, it can be understood that the above embodiments are exemplary and should not be construed as limitations of the present disclosure. Those skilled in the art can make changes, modifications, substitutions, and variations to the above embodiments within the scope of the present disclosure.

What is claimed is:

1. A load adjustable electrode hot water boiler, comprising: a drum (10), zero electrode cylinders (11), phase electrodes (12), and water distributors (13); wherein the amount of the zero electrode cylinders (11) is three, and the zero electrode cylinders (11) are evenly and annularly distributed in the drum (10); the phase electrodes (12) are coaxially disposed in the zero electrode cylinders (11) respectively; the water distributors (13) are located directly below the zero electrode cylinders respectively (11); an isolation shield (22) is slidably assembled with a corresponding one of the water distributors (13), and the isolation shield (22) is configured to rotate and lift relative to the corresponding water distributor (13); and the isolation shield (22) is further configured to sleeve on a corresponding one of the phase electrodes (12) during a rising process of the isolation shield (22), thereby avoiding an ion migration between the corresponding phase electrode (12) and a corresponding one of the zero electrode cylinders (11); and
wherein a top of the isolation shield (22) is provided with vertical plates (531) and curved plates (532); the vertical plates (531) are configured to slide radially along the isolation shield (22), and the vertical plates (531) are further configured to attach tightly to a surface of the corresponding phase electrode (12) and move away from the surface of the corresponding phase electrode (12) by sliding; the curved plates (532) are rotatably disposed at ends of the vertical plates (531) respectively; and the curved plates (532) are configured to attach to a curved surface of the corresponding phase electrode (12) with a movement of the corresponding isolation shield (22).

2. The load adjustable electrode hot water boiler as claimed in claim 1, wherein an inside of the drum (10) is fixedly installed with a support (14) and a base (15) located below the support (14), the zero electrode cylinders (11) are fixedly installed on the support (14), and the water distributors (13) are disposed on the base (15).

3. The load adjustable electrode hot water boiler as claimed in claim 2, wherein a bracket (21) is provided above the base (15), hold hoops (23) are provided on the bracket (21), and the isolation shield (22) is rotatably assembled in a corresponding one of the hold hoops (23).

4. The load adjustable electrode hot water boiler as claimed in claim 3, wherein an inside of the base (15) is provided with a lead screw (32), and a bottom end of the lead screw (32) extends to an outside of the drum (10) and is connected to a servo motor (31); a nut (33) is fixedly installed in the bracket (21); and the nut (33) is threaded with an outside of the lead screw (32).

5. The load adjustable electrode hot water boiler as claimed in claim 4, wherein an outside of each of the water distributors (13) is provided with a rotary table (41), a top of the rotary table (41) is fixedly installed with telescopic rods (42), and a telescopic end of each of the telescopic rods (42) is fixedly connected to the isolation shield (22); an outside of the rotary table (41) is fixedly installed with a ring gear (43); and the outside of the lead screw (32) is fixedly installed with a gear (44) that meshes with the ring gear (43).

6. The load adjustable electrode hot water boiler as claimed in claim 1, wherein the top of the isolation shield (22) is fixedly installed with support blocks (51), and an inside of each of the support blocks (51) is slidably connected to a horizontal bar (52); the horizontal bar (52) is horizontally disposed along a radial direction of the isolation shield (22); an installation plate (521) is fixedly installed on the horizontal bar (52) and the installation plate (521) is located at a side of the support block (51); a spring (522) is provided between the installation plate (521) and the support block (51); and the spring (522) is in a compressed state; the vertical plate (531) is fixedly installed at an end of the horizontal bar (52); a torsion spring is provided between the a corresponding one of the vertical plates (531) and a corresponding one of the curved plates (532), and the torsion spring is configured to apply a torsion force to the corresponding curved plate (532) along a centerline of the corresponding phase electrode (12).

7. The load adjustable electrode hot water boiler as claimed in claim 6, wherein an outside of the isolation shield (22) is provided with an annular plate (61) that slides along a height direction of the isolation shield (22), a bottom of the annular plate (61) is provided with an air cylinder (62), and the air cylinder (62) is configured to drive the annular plate (61) to rise and descend; a top of the annular plate (61) is fixedly installed with a wedge-shaped plate (63), and a side of the wedge-shaped plate (63) facing away from the isolation shield (22) is an inclined surface; an inside of the horizontal bar (52) defines a transverse slot (523) along a length direction of the horizontal bar (52); and a top of the wedge-shaped plate (63) is slidably connected to the transverse slot (523).

8. The load adjustable electrode hot water boiler as claimed in claim 1, wherein a top of the drum (10) is fixedly installed with electrode tube seats (16), an inside of each of the electrode tube seats (16) is fixedly installed with an electrode porcelain sleeve (72), the corresponding phase electrode (12) is fixedly installed at a bottom of the electrode porcelain sleeve (72), a wire clamp (73) is provided at a top of the electrode porcelain sleeve (72), and a conductive copper rod (71) is provided between the wire clamp (73) and the corresponding phase electrode (12).

9. The load adjustable electrode hot water boiler as claimed in claim 8, wherein an outside of the electrode porcelain sleeve (72) is provided with a protruding ring seat (741) disposed in the electrode tube seat (16), and sealing rings (742) are provided on two sides of the protruding ring seat (741); a surface of each of the sealing rings (742) facing towards the protruding ring seat (741) is a spherical curved surface; and a surface of each of the sealing rings (742) facing away from the protruding ring seat (741) is a plane.

10. The load adjustable electrode hot water boiler as claimed in claim 8, wherein a bottom of each of the electrode tube seats (16) is provided with an upper insulation sheath (17), and a top of each of the water distributors (13) is provided with a lower insulation sheath (18).
